(19) United States
(12) Patent Application Publication
(10) Pub. No.: US 2023/0184576 A1
(43) Pub. Date: Jun. 15, 2023

(54) POOL CONDITION MONITORING APPARATUS AND METHOD

(71) Applicant: Robert HARRISON, Huddersfield Yorkshire (GB)

(72) Inventor: Robert HARRISON, Huddersfield Yorkshire (GB)

(21) Appl. No.: 17/769,562

(22) PCT Filed: Oct. 15, 2020
(86) PCT No.: PCT/GB2020/052598

§ 371 Date: Apr. 15, 2022

(30) Foreign Application Priority Data
Oct. 18, 2019 (GB) 1915154.7

(51) Int. Cl. G01F 23/263; G01F 23/80; E04H 4/12; E04H 4/14

(52) U.S. Cl. CPC G01F 23/268; G01F 23/804; E04H 4/1272; E04H 4/14

(57) ABSTRACT

Embodiments of the present invention provide a pool condition monitoring device (50) comprising a hermetically sealable housing (52) having a floor (54) defining a lower external surface (56) of the housing. A sensing probe (60) depends from the lower external surface of the housing, for immersion in water (18) in the pool along a part of the length of the probe. An electronic circuit (7) and power source is within the housing, the electronic circuit including a telemetry device (120), suitable to connect the device to a remote system via a local area wireless network or a mobile telephone station. The sensing probe (60) is adapted to return a value to the electronic circuit depending on the degree of immersion of the probe in water, and thereby to indicate a fill level of the pool. The probe is sized to pass through a circular hole (40) of less than 3 cm in diameter in a lid (26) of a pool overspill sump (22), whereby the device can be supported by the lower external surface of the housing on the lid. The sump (22) is arranged with respect to the pool such that water in the sump is at the level (20) of water in the pool, the sump including a drain (38) from which water may be drawn for cleaning purposes and return elsewhere to the pool.

### TECHNICAL FIELD

The present disclosure relates to a pool condition apparatus and method, in particular a device for monitoring and reporting the fill level of a swimming pool.

### BACKGROUND

Swimming pools are common facilities, especially in holiday locations around the world that have a warm climate. Swimming pools may be located adjacent people's homes or in leisure facilities of hotels and dubs or the like. In any event, swimming pools require maintenance on a regular basis if their condition is to remain favourable for users to enjoy. This applies to the water cleanliness, as well as its temperature. In hot climates, maintaining the correct fill level is important, not only because that may be an aesthetic quality in its own right (for example, with infinity pools that have a constant overflow of at least one (part of a) wall of the pool), but also potentially for water cleaning purposes. Pools frequently have an overspill sump, at one aspect of the pool, into which water at the surface of the pool flows and from which water is drawn by a pump, through a filter mechanism, to dean and condition the water. Conditioning may involve heating the water before it is returned elsewhere in the pool, possibly quite remotely from the sump.

If the water level in a pool falls below the level of an overspill sump, such conditioning treatment may fail to function. Consequently, swimming pool maintenance involves topping up the pool from time to time with fresh water to keep the water level within acceptable limits. This is particularly the case in hot climates and when the pool is in active use where significant quantities of water may be lost to the environment through evaporation and splashing. However, topping up swimming pools may involve leaving a water pipe valve open for some considerable time, which risks the pool overflowing if maintenance personnel overlook closing the valve when the pool is filled to its desired level.

Swimming pool owners or maintenance personnel may not always be present at the site of the pool. Such is the case with many holiday homes that owners visit infrequently or intermittently. Usually, staff may be employed to visit the pool periodically to check on the pool and conduct periodic cleaning or other maintenance tasks. Such staff may not have the time to wait while a pool is being topped up and ray forget that they have opened a valve to do that.

FR2966859 discloses a system to monitor a number of different swimming pool water parameters including pH, salinity, oxidation-reduction potential, etc and comprises a submerged housing including probes in the water to detect and measure these parameters and transmit them to a remote receiver by way of radio telemetry. The receiver includes a display on which the values of the parameters detected can be shown to a user, and an alarm may be raised when these values depart from predetermined ranges, whereby the user may take requisite corrective action. The submerged housing includes a radio antenna that is disposed above water level in the pool and adjacent the antenna is a conductor electrically isolated from the water in the pool whose capacitance is affected by the degree of submergence of the conductor beneath water level. That capacitance is monitored and indicates fill level of the pool, which may also be displayed on the remote receiver's display.

U.S. Pat. No. 6,006,605 discloses a float operated valve for disposal at the edge of a pool, the valve serving to permit water to enter the pool when its level drops as detected by the float.

U.S. Pat. No. 5,878,447 discloses a water regulator apparatus for automatically filling a swimming pool, the apparatus to be disposed in an existing built-in skimmer of a pool having a water fill line. Electronic (radio) communication between the regulator and a valve in the water fill line causes the water fill line to be opened when sensing means in the apparatus detects a drop in fill level of the pool below a threshold level. US2019/0136557 provides a similar arrangement where the apparatus communicates with a user through cloud-based analytic serves.

It is an object of embodiments of the invention to improve the arrangements previously disclosed, and at least mitigate one or more of the problems of the prior art.

Most modern swimming pools do include a poolside sump or skimmer in contact with the water in the pool and enclosing water at the level of the water in the pool. The sump may include a weir over which water in the pool normally spills to fill the sump. The sump has a drain from which water is drawn for filtration and heating purposes. The drain may be protected by a coarse filter to catch toys, objects, debris floating in the pool that overspill the weir. The weir also protects the internal volume of the sump from access by swimmers in the pool. With the sump being positioned at the surface of the pool, in the wall of the pool at its edge, it is usually covered by a removable lid capable of bearing the weight of users and being flush with the edge surface of the pool. The lid may be easily removable, usually just being retained by gravity on a peripheral internal shoulder defined in the wall of the sump. The lid enables the top of the sump to be opened to permit access to the sump to retrieve objects and large debris caught in the sump. The lid may typically have a central finger hole, through which a user can insert a finger to grip the lid, and lift it to remove it.

### SUMMARY OF THE INVENTION

The present invention provides, in a first aspect, a pool condition monitoring device comprising:
a hermetically sealable housing having a floor defining a lower external surface of the housing,
a sensing probe depending from the lower external surface of the housing, for immersion in water in the pool along at least a part of the length of the probe,
an electronic circuit and power source within the housing,
wherein the electronic circuit includes a telemetry device, suitable to connect the device to a remote system via a local area wireless network or a mobile telephone station;
wherein the sensing probe returns a value to the electronic circuit depending on the degree of immersion of the probe in water, thereby to indicate a fill level of the pool;
wherein the probe is sized to pass through a circular hole in a support surface, the hole being of no more than 3 cm in diameter, whereby the device can be supported by the lower external surface of the housing on the support surface.
While not forming part of the invention in this aspect, the support surface may be the aforementioned lid of the sump of a typical swimming pool as described above, the probe passing through the finger hole and being long enough to be immersed in the water in the sump.

In a second aspect, the present invention provides said device in combination with a swimming pool overspill sump such that water in the sump is at the level of water in the pool, the sump including a drain from which water may be drawn for cleaning purposes and return elsewhere to the pool, wherein the sump comprises a lid in a surface adjacent the pool, a finger hole being provided in the lid through which said sensing probe depends, the device being supported on said lid by said lower external surface of the housing.

The pool may comprise a swimming pool or garden pond or other liquid container whose fill level is desired to be monitored.

In a third aspect, the present invention comprises a method of monitoring the fill level of a pool, wherein the pool comprises an overspill sump such that water in the sump is at the level of water in the pool, the sump including a drain from which water is drawn for cleaning purposes and return elsewhere to the pool, wherein the sump comprises a lid in a surface adjacent the pool, a finger hole being provided in the lid, wherein the method comprises providing a device as defined above and passing the sensing probe through the finger hole so that the probe is partially immersed in water in the sump and the device is supported on said lid by said lower external surface of the housing, and wherein the sensing probe returns a value to the electronic circuit depending on the degree of immersion of the probe in water and the telemetry device connects the pool condition monitoring device to a remote system via a local area wireless network or a mobile telephone station and notifies the remote system of the degree of immersion of the probe in water and thereby the fill level of the pool.

The housing may have sufficient rigidity to withstand the pressure applied by an adult male human standing on the housing. It may be constructed from ABS plastics material, for instance that has both sufficient strength as well as being relatively transparent to radio signals transmitted and received by the telemetry device.

The housing may have a tapered top surface to reduce the risk of lateral pressure being applied to the housing when the probe is inserted through the finger hole in a sump lid and the device is resting on the lid. Such a risk may be experienced through users knocking the housing when walking around the pool.

A remote system for use with the device according to the present disclosure may comprise a monitor program running in a computer connected to the internet and adapted to receive communications from one or more devices as defined above, wherein the program is arranged to issue an alert when it records a change in the fill level of a pool being monitored by a device beyond a desired threshold.

The sensing probe may be capacitive, and be disposed within a tubular body extending from the housing, the tubular body being sealed with the housing. The sensing probe may include a temperature sensor to return a value to the electronic circuit dependent on the temperature at the probe, the telemetry being arranged to transmit the temperature periodically to the remote system.

The telemetry device may include a wifi signal transceiver, for connection to a local area wifi network. A computer on the network may comprise said remote system and run said monitor program itself, receiving said communication from the pool condition monitoring device. Alternatively, a computer on the network may simply receive the communication from the pool condition monitoring device for onward transmission through an internet connection to the remote system. Further alternatively, the telemetry device of the pool condition monitoring device may be arranged to communicate directly through the local area wifi network and internet to the remote system.

Alternatively, or in addition, the telemetry device may include a mobile telephone transceiver for connection of the pool condition monitoring device with the remote system through a mobile telephone network.

The remote system may be adapted to receive communications from multiple pool condition monitoring devices at different locations, whereby a communication from a pool condition monitoring device includes an identification signal to inform the remote system about which device it is.

The pool condition monitoring device may comprise two physical parts, a sensor tube which supports the sensing probe and a processing enclosure comprising said housing. The pool condition monitoring device must be fixed in a permanent position so that water in the pool will move up and down the outside the tube as the water level varies. Gravity acting on the mass of the pool condition monitoring device may be arranged to be adequate to counteract any buoyancy of the tube when immersed in water.

The sensor tube is sealed from the surrounding environment. It may be made of a non-metallic material capable of acting as a barrier against the water. Two strips of conducting material may be attached along the inside length of the tube and to either side of the tube to create two parallel plates forming the two electrodes of a capacitor. Water moving up and down the outside of the tube will act as a dielectric and affect the capacitance of the capacitor, which capacitance is detected by the electronic circuit and comprises the value returned by the sensing probe to the electronic circuit. A temperature sensor may be placed in the tube to monitor fluid temperature. Preferably, the sensor is at the base of the tube, to be as remote as possible from the fluid surface, whose temperature may be influenced by the external environment and not be as representative of temperature of the main body of the fluid.

The processing enclosure is also sealed from the environment and the electronic circuit may comprise five logical units, said logical units comprising:
1. said telemetry device;
2. a power supply comprising a battery or solar powered source including a power regulator to achieve a desired voltage for the electronic circuit;
3. a central micro processing unit controlling each logical unit, comprising a low power microprocessor, capable of sleeping in a low power state and used to enable the power regulator at selected intervals;
4. a capacitance reader comprising an integrated circuit capable of converting the capacitance of the two parallel plates of the sensing probe into a digital value; and, optionally,
5. a temperature reader comprising an integrated circuit capable of converting temperature detected by the temperature sensor into a digital value.

The skilled person has the ability without further description to implement the electronic circuit. However:
the telemetry device may comprise an ESP-12S wifi chip, which is based on the ESP8266 chip;
the power supply may comprise three AA batteries and an MCP1825 power regulator;
the microprocessor may comprise an Atmel AtTiny integrated circuit;
the capacitance reader may comprise a Texas Instruments FD2214 capacitance sensor; and
the temperature reader may comprise a Dallas DS18B20U+ chip using a Dallas DS18B12 temperature sensor.

Power being supplied by low voltage batteries eliminates danger of electrical injury in a wet environment.

However, other suitable components are available. The AtTiny microprocessor is capable of consuming less than 1 μA of current whilst in sleep mode and activating itself at regular intervals switch on the power regulator, to record the capacitance and temperature detected by the sensing probe and transmit the measured values through the telemetry device.

While the present disclosure is framed with respect to a swimming pool fill level monitoring device, system and method, where the fluid in the pool will be water, it is to be understood that the invention has application in respect of other containers of fluid, where the fluid is not necessarily water. Therefore, where the term “pool” should not be construed as being limited to a swimming pool unless the context makes clear, and the term “water” should be understood to include other fluids within its ambit unless the context, for example in the case of swimming pools, makes it clear that the reference is indeed to water and not ant other fluid.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1 shows a side section of part of a swimming pool at an edge where a sump for extraction of water from the surface of the pool is disposed, a pool condition monitoring device in accordance with the invention being supported on a lid of the sump;

FIG. 2 is a cross-section through the pool condition monitoring device in FIG. 1; and

FIG. 3 is a schematic drawing of the circuit arrangements of the pool condition monitoring device in FIG. 1.

### DETAILED DESCRIPTION

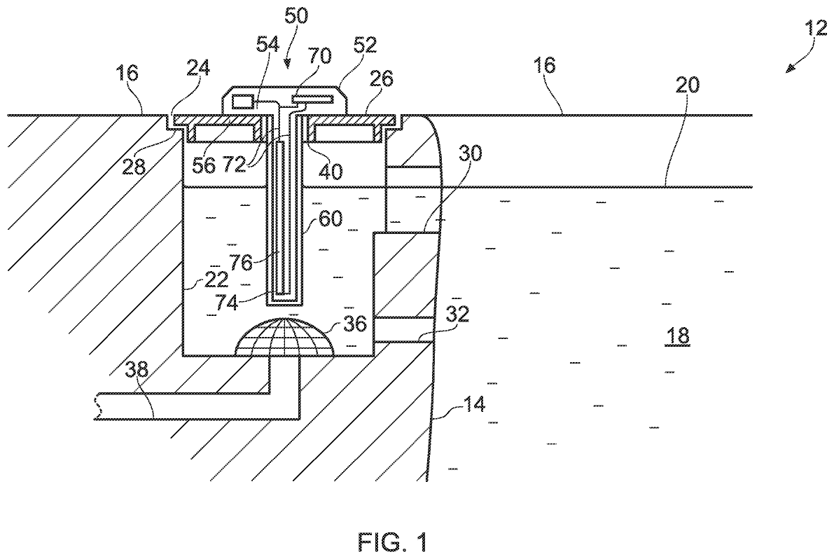

In FIG. 1, a swimming pool 12 has a wall 14 with surrounding walkway 16 and contains water 18 filled to a level 20. A sump 22 is disposed in the wall 14 having an opening 24 in the walkway that is closed with a lid or cover 26. The lid 26 is received on a shoulder 28 formed in the opening so that the top of the lid is flush with the walkway 16.

The wall 14 includes a weir opening 30 over which water in the pool spills to fill the sump, whereby the level of water in the sump is the same as that 20 in the main body of the pool. A further opening 32 may be provided to ensure that the sump is supplied with water, even if the level 20 should fall below the level of the weir opening 30. At the base of the sump is a coarse filter 36 protecting an extract pipe 38 from the sump from which water in the sump is periodically (or continuously) drawn for filtration, cleaning and/or heating before being returned elsewhere to the pool to maintain the fill level. The arrangement is part of the conditioning system for the pool and draws water from the surface 20 of the pool that frequently has floating debris such as oil, insects, leaves etc.

Larger debris is caught by the coarse filter 36, including toys and other play items used by users of the pool that spill over into the sump 30. These item may be recovered by users removing the lid 26 to gain access to the sump. For this purpose, a hole 40 is disposed in the lid for a user to insert their finger and lift the lid from the sump.

This arrangement is ubiquitous. It is employed in many swimming pools in establishments around the world. Where such pools are tended regularly by their owners or by staff employed to maintain swimming pools, monitoring of pool depth can be done manually. However, many swimming pools in private residences are left unattended for extended periods of time, particularly pools in holiday homes. Whilst the owners of such pools will frequently employ contract maintenance companies to attend their pools, this may only be on a weekly or bi-weekly basis. During winter months, less frequent visits may be made. During peak holiday seasons, when guests of holiday home owners are visiting and using pools, much water may be splashed from the pool, and typically this is exacerbated in hot weather when the pool is more frequently used. In this case, the water level in the pool may drop and potentially the sump 22 might be entirely depleted of water risking damage to pump mechanisms drawing water from the sump. Another source of water depletion is of course the potential for leakage from the pool.

In many circumstances, therefore, the ability to monitor fill levels of swimming pools is desirable. The same is true, for different reasons, of water temperature. Many owners and users of swimming pools like to know what the temperature of the water is. Typically, thermometers are inserted into the pool, perhaps supported by string or cord and dangled into the water from the edge of the pool. However, this does not permit remote monitoring. Also, dangling equipment into the body of a swimming pool from the side risks the equipment being disturbed or even damaged by activity in the pool.

Thus a pool condition monitoring device in accordance with the present invention solves a number of problems, as described further below.

With reference to FIG. 1, a pool condition monitoring device 50 comprises a housing 52 including a floor 54 having a lower surface 56 configured to rest on the top surface of the lid 26. A tubular sensing probe 60 depends from the lower surface 56, being sized to fit through the finger hole 40 and be partially immersed in water in the sump 22. The housing 52 contains an electronic circuit 70, described further below, from which depends leads 72 to a temperature sensor 74 and a capacitive element 76.

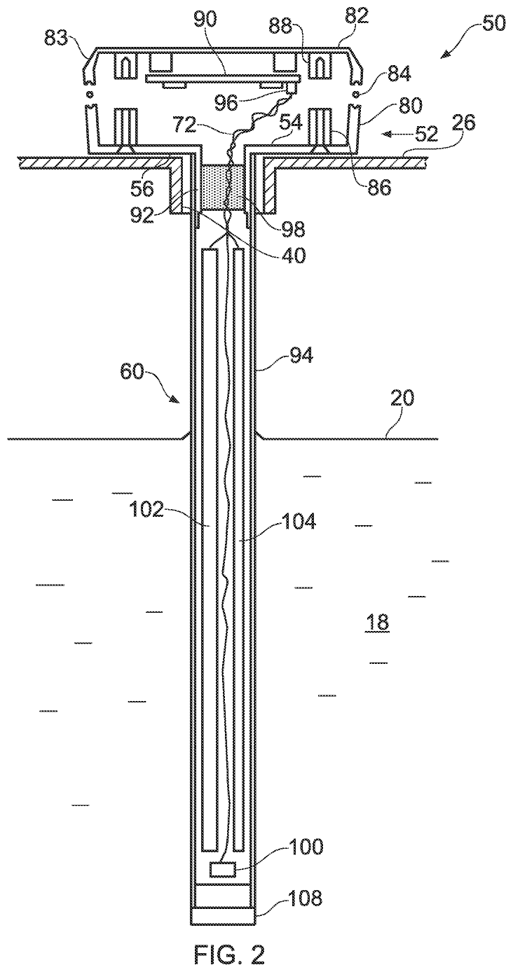

Referring to FIG. 2, the housing 52 comprises a cup-like base 80 and a cover 82. An O-ring seal 84 is disposed between the rims of the cover and base so that, when they are drawn towards one another by screws (not shown) passing from below through several bosses 86 formed on the floor 54 and threaded into receptors 88 formed in the cover 82, the housing 52 is hermetically sealed against the external environment. The housing constitutes a processing enclosure and receives a circuit board 90 mounting electronic components described further below. The processing enclosure also has provision for receiving batteries (not shown) to power the components mounted on the circuit board 90.

The floor 54 of the housing has a downwardly depending open flange 92, around which is bonded a tube 94. The leads 72 are connected with a dismountable plug and socket 96 to the board 90 and extend through the flange 92 into the tube 94. A resinous plug 98 may be provided to seal the bore of the flange 92 around the leads 72 completing the hermetic sealing of the housing. r

The leads 72 lead to a temperature sensor 100, near the distal end of the tube 94, and to two foil plates 102,104 forming a capacitor 106. The foil plates are separated from one another to avoid electrical contact and lie against the internal surface of the tube 94. Water 18 around the tube acts as a dielectric and alters the capacitance of the capacitor 104, depending on its level 20. A plug 108 may be disposed in the tube to seal the tube, which may render the plug 98 unnecessary to seal the housing/enclosure 50 (assuming that the tube 94 is sealed to the flange 92.

The length required of the tube 94 depends on the geometry of the particular sump 22 in which it is intended to be deployed, but the length is not critical provided that the under surface 56 of the housing 52 is seated on the lid 26 (without the tube resting on the floor of the sump 22) so that the device 50 is stable in use, and that it depends into the water 18 when that is at its desired fill level 20.

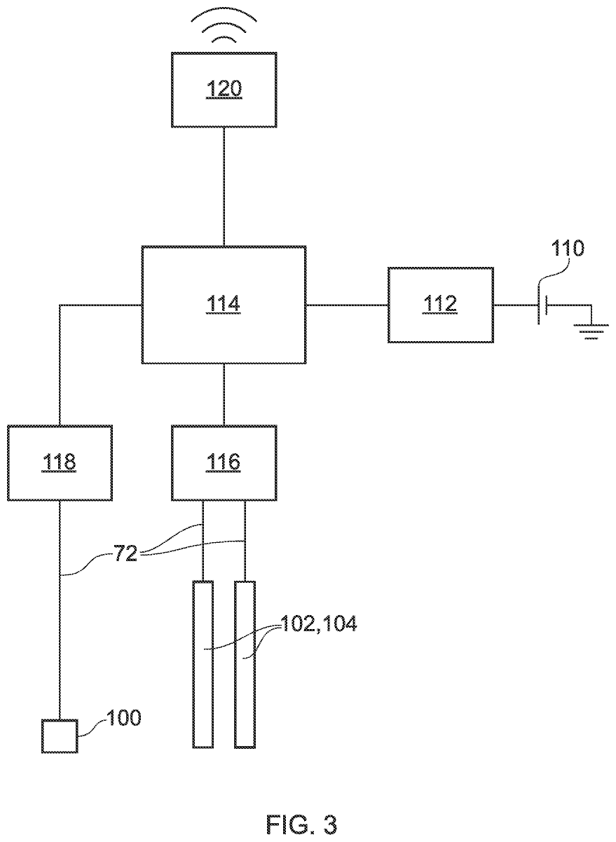

Turning to FIG. 3, the electronic components in the pool condition monitoring device 50 comprise a battery 110 connected to a power regulator 112, which conveniently is an MCP1825 component. The battery 110 may instead be, or include, a solar panel (not shown) disposed in or forming part of the surface of the lid 82, and exposed to sunlight impinging on it. The power supply from regulator 112 is connected to a microprocessor 114 that controls the electronic components of the device. The microprocessor may be an AtTiny CPU component. The microprocessor is in turn connected to a capacitance reader 116 (which may comprise an FD2214 component) and a temperature reader 118 (which may comprise a DS18B20U+ component). The two readers 116,118 are connected by the leads 72 to the capacitor foils 102,104 and to the temperature sensor 100 respectively.

Finally, the microprocessor 114 is also connected to the telemetry device 120. In operation, the microprocessor is arranged to operate in sleep mode for a period of fifteen minutes. In sleep mode, a processor such as the AtTiny processor drains very little power from the power source, as little as 1 μA of current. At the end of that period, the processor wakes and provides power to the capacitance reader 116 and a temperature reader 118 and receives digital values from them of the capacitance of the foils 102,104 and temperature sensed by sensor 100.

These values are then passed to the telemetry device 120 which wirelessly transmits the measured values to the remote system (not shown). The communication route to the remote system is optional and may be selected from:
1. connection by wifi to a router (not shown) positioned within range of the pool condition monitoring device; or
2. by direct mobile telephony.

In the case of wifi connectivity, the telemetry device may be configured for direct connection to the internet via the router to which it is connected and its mode of communication with the internet (for example through a telephone connection) or to a computer on a local area network connected to the router. Such connectivity is within the ability of persons skilled in the art and requires no further elucidation herein.

The remote system which receives the capacitance and temperature data from the pool condition monitoring device records the data and makes comparisons with previous or threshold values and acts as desired. However, the telemetry device 120 maintains the communication link with the remote system sufficiently long to receive a response from the system, which may comprise, for example, a firmware update. In the absence of a response requiring any action by the microprocessor, it goes to sleep for the next period of fifteen minutes. Of course, while sleep periods of fifteen minutes are given, this is merely an example period and longer or shorter periods may be selected. Shorter periods will result in shorter battery life, whereas longer periods may result in missing valuable information, particularly if any communications should fail for any reason. The use of a solar panel and storage capacitor could avoid the issue of battery life. The storage capacitor could instead be a rechargeable battery.

In the event that the remote system detects a change in fill level or temperature that exceeds a predetermined threshold, before sending an alert to interested parties, the remote system may instruct the microprocessor to repeat the measurements made and within a shorter time period than the standard 15 minute timeframe, for example after 15 seconds. Should any departure from desired levels be maintained on a second measurement, a third measurement may be requested in order to establish whether the changes detected are consistent and indicative of a true departure from desired levels. Indeed, the time interval of sleep periods may be determined by the remote system and communicated to the microprocessor on each occasion and may be shorter or longer than 15 minutes as desired.

It is to be noted that the cover 82 has a tapered or chamfered top edge 83. Moreover, the housing 52 has a low profile, of less than 5 cm, and preferably less than 3 cm, in height. Both the chamfered top edge and the low profile reduce the risk of the monitoring device being kicked or dislodged in use, especially when people are playing or walking around the pool. An advantage of the application of the pool condition monitoring device within and just above the sump 22 is that none of it intrudes into the major volume of the pool 12. It is unobtrusive and largely isolated from risk of inadvertent damage or movement by users of the pool. Of course, given that the fill level of the pool is not absolutely measured, but that the device reports only a relative degree of immersion of the sensing probe 60 in the water 18, it is necessary for the vertical position of the device with respect to the pool 12 to remain static over time so that any change in capacitance measured by the device reflects a change in fill level 20 of the water and not some artefact caused by vertical movement of the device itself.

Indeed, when first set up, a user is required to calibrate the device by informing the remote system, once the pool condition monitoring device is in position and a desired level 20 of the water is established, so that a capacitance value measured at that point in time is reflective of the desired fill level. Subsequent changes in capacitance will be predictive of specific change in fill level as a function of the response of the pool condition monitoring device.

On detecting a change of level that exceeds a predetermined threshold value, the remote system may issue an alert whereby a person responsible for the maintenance of the pool may be advised that the level has changed undesirably. This could enable a maintenance person to attend the pool in a short period of time to correct the fill level. This may be by operating a valve to allow water to fill the pool until the correct fill level is reached. However, a further application could be to remind a maintenance person that a pool has been adequately filled and a water valve can be turned off. The form of alert may comprise a text message sent to a mobile telephone associated with the pool. The system includes the possibility of multiple pools being monitored by a single remote system, where data sent by a given pool condition monitoring device includes a reference to the pool being monitored, which may be compared with a database of pools and contact details associated with each one.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A pool condition monitoring device comprising:
a hermetically sealable housing having a floor defining a lower external surface of the housing;
a sensing probe depending from the lower external surface of the housing, for immersion in water in the pool along a part of the length of the probe; and
an electronic circuit and power source within the housing, wherein:
the electronic circuit includes a telemetry device, suitable to connect the device to a remote system via a wireless connection;
the sensing probe is adapted to return a value to the electronic circuit depending on the degree of immersion of the probe in water, and thereby to indicate a fill level of the pool;
the telemetry device is adapted to communicate the fill level to the remote system; and
the probe is sized to pass through a circular hole of less than 3 cm in diameter in a support surface, whereby the device can be supported by the lower external surface of the housing on the support surface.

2. A device as claimed in claim 1, wherein the housing has sufficient rigidity to withstand the pressure applied by an adult male human standing on the housing.

3. A device as claimed in claim 1, wherein the housing has a chamfered edge to its top surface to reduce the risk of lateral pressure being applied to the housing when the probe is inserted through the finger hole in a sump lid and the device is resting on the lid.

4. A device as claimed in claim 1, wherein the sensing probe is capacitive, and be disposed within a tubular body extending from the housing, the tubular body being sealed with the housing.

5. A device as claimed in claim 1, wherein the sensing probe includes a temperature sensor to return a value to the electronic circuit dependent on the temperature at the probe, the telemetry being arranged to transmit the temperature periodically to the remote system.

6. A device as claimed in claim 1, wherein the telemetry device includes a transceiver, for wireless connection to a communications network.

7. A device as claimed in claim 6, wherein the transceiver is a WiFi signal transceiver, for connection to a local area network, or wherein the transceiver is a mobile telephone transceiver for connection of the pool condition monitoring device with the remote system through a mobile telephone network.

8. A device as claimed in claim 1 comprising two physical parts, a sensor tube which supports the sensing probe and a processing enclosure comprising said housing.

9. A device as claimed in claim 1, wherein the mass of the pool condition monitoring device is arranged so that gravity acting on device is adequate to prevent any buoyancy of the tube when immersed in water from floating the device.

10. A device as claimed in claim 1, wherein
the sensor tube is sealed from the surrounding environment and is made of a non-metallic material capable of acting as a barrier against the water;
two strips of conducting material are attached along the inside length of the tube and to either side of the tube to create two parallel plates forming the two electrodes of a capacitor, whereby water moving up and down the outside of the tube acts as a dielectric and affects the capacitance of the capacitor, which capacitance is detected by the electronic circuit and comprises the value returned by the sensing probe to the electronic circuit.

11. A device as claimed in claim 1, wherein a temperature sensor is disposed at the base of the tube to return a value indicative of the pool temperature detected to the electronic circuit.

12. A device as claimed in claim 1, wherein the electronic circuit comprises logical units, the logical units comprising:
1. said telemetry device;
2. a power supply comprising a battery or solar powered source including a power regulator to achieve a desired voltage for the electronic circuit;
3. a central micro processing unit controlling each logical unit, comprising a low power microprocessor, capable of sleeping in a low power state and used to enable the power regulator at selected intervals; and,
4. a capacitance reader comprising an integrated circuit capable of converting the capacitance of the two parallel plates of the sensing probe into a digital value.

13. A device as claimed in claim 1 in combination with a pool overspill sump, the sump being arranged with respect to the pool such that water in the sump is at the level of water in the pool, the sump including a drain from which water may be drawn for cleaning purposes and return elsewhere to the pool, wherein the sump comprises a lid in a surface adjacent the pool, a finger hole being provided in the lid through which said sensing probe depends, the device being supported on said lid by said lower external surface of the housing.

14. A combination as claimed in claim 13, in which the pool comprises a swimming pool or garden pond or other liquid container whose fill level is desired to be monitored.

15. A method of monitoring the fill level of a pool, wherein:
the pool comprises an overspill sump such that water in the sump is at the level of water in the pool, the sump including a drain from which water is drawn for cleaning purposes and return elsewhere to the pool;
the sump comprises a lid in a surface adjacent the pool, a finger hole being provided in the lid; and
the method comprises:
providing a device as claimed in claim 1;
passing the sensing probe of the device through the finger hole so that the probe is partially immersed in water in the sump and the device is supported on said lid by said lower external surface of the housing, and wherein:
the sensing probe returns a value to the electronic circuit depending on the degree of immersion of the probe in water; and
the telemetry device connects the pool condition monitoring device to a remote system via a local area wireless network or a mobile telephone station and notifies the remote system of the degree of immersion of the probe in water and thereby the fill level of the pool.

16. A remote system in combination with a device as claimed in claim 1, the remote system comprising a monitor program running in a computer connected to the internet and adapted to receive communications from one or more of said devices, wherein the program is arranged to issue an alert when it records a change in the fill level of a pool being monitored by a device beyond a desired threshold.

17. A combination as claimed in claim 16 adapted to receive communications from multiple pool condition monitoring devices at different locations, whereby a communication from a pool condition monitoring device includes an identification signal to inform the remote system about which device it is.

18. A combination as claimed in claim 16, wherein the telemetry device includes a WiFi signal transceiver for wireless connection to a local area network, and wherein said remote system comprises a computer on the local area network arranged itself to run said monitor program, receiving said communication from the pool condition monitoring device, or wherein a computer on the local area network is adapted to receive the communication from the pool condition monitoring device and to transmit the communication through an internet connection to the remote system.

19. A combination as claimed in claim 16, wherein the telemetry device includes a WiFi signal transceiver for wireless connection to a local area network, and wherein the telemetry device of the pool condition monitoring device is arranged to communicate directly with the remote system through the local area network and internet.

20. A device as claimed in claim 11, wherein the electronic circuit comprises logical units, the logical units comprising:
1. said telemetry device;
2. a power supply comprising a battery or solar powered source including a power regulator to achieve a desired voltage for the electronic circuit;
3. a central micro processing unit controlling each logical unit, comprising a low power microprocessor, capable of sleeping in a low power state and used to enable the power regulator at selected intervals;
4. a capacitance reader comprising an integrated circuit capable of converting the capacitance of the two parallel plates of the sensing probe into a digital value; and,
5. a temperature reader comprising an integrated circuit capable of converting temperature detected by the temperature sensor into a digital value.
